(19) United States
(12) Patent Application Publication
(10) Pub. No.: US 2006/0040163 A1
(43) Pub. Date: Feb. 23, 2006

(54) Method of enhancing fuel cell water management

(75) Inventors: Cheng Yang-Tse, Rochester Hills, MI (US); Anita M. Weiner, West Bloomfield, MI (US); Curtis A. Wong, Macomb Township, MI (US); Daniel Rodak, Southfield, MI (US); Gayatri Vyas, Rochester Hills, MI (US); Maria C. Militello, Macomb, MI (US)

Correspondence Address: General Motors Corporation;300 Renaissance Center, Legal Staff, MC 482-C23-B21, PO Box 300, Detroit, MI, 48265-3000, US

(73) Assignee: GM Global Technology Operations, Inc., Detroit, MI (US)

(21) Appl. No.: 11/206,479

(22) Filed: Aug. 18, 2005

Related U.S. Application Data
(60) Provisional application No. 60/603,577, filed on Aug. 23, 2004.

(51) Int. Cl. H01M 8/02

(52) U.S. Cl. 429/34; 427/115

(57) ABSTRACT

Methods and systems for enhancing water management capabilities of a fuel cell are disclosed. The methods include changing the surface energy of a fuel cell element by depositing, via physical vapor deposition, a thin film on the surface of the fuel cell element. Sputtering and evaporation can be employed as the physical vapor deposition technique.

### CROSS-REFERENCE TO RELATED APPLICATION

The instant application claims priority to U.S. Provisional Patent Application Ser. No. 60/603,577, filed Aug. 19, 2004, the entire specification of which is expressly incorporated herein by reference.

### FIELD OF THE INVENTION

The present invention relates generally to fuel cells which generate electricity to power vehicles or other machinery. More particularly, the present invention relates to a method of enhancing water management of fuel cells by using physical vapor deposition (PVD) of a thin film to form super hydrophilic surfaces on fuel cell components, thereby reducing retention of water on the surfaces and promoting transport of water in the fuel cell.

### BACKGROUND OF THE INVENTION

Fuel cell technology is a relatively recent development in the automotive industry. It has been found that fuel cell power plants are capable of achieving efficiencies as high as 55%. Furthermore, fuel cell power plants emit only heat and water as by-products.

Fuel cells include three components: a cathode, an anode and an electrolyte which is sandwiched between the cathode and the anode and passes only protons. Each electrode is coated on one side by a catalyst. In operation, the catalyst on the anode splits hydrogen into electrons and protons. The electrons are distributed as electric current from the anode, through a drive motor and then to the cathode, whereas the protons migrate from the anode, through the electrolyte to the cathode. The catalyst on the cathode combines the protons with electrons returning from the drive motor and oxygen from the air to form water. Individual fuel cells can be stacked together in series to generate increasingly higher voltage electricity.

In a Polymer-Electrolyte-Membrane (PEM) fuel cell, a polymer electrode membrane serves as the electrolyte between a cathode and an anode. The polymer electrode membrane currently being used in fuel cell applications requires a certain level of humidity to facilitate conductivity of the membrane. Therefore, maintaining the proper level of humidity in the membrane, through humidity/water management, is desirable for the proper functioning of the fuel cell. Irreversible damage to the fuel cell may occur if the membrane dries out.

In order to prevent leakage of the hydrogen fuel gas and oxygen gas supplied to the electrodes and prevent mixing of the gases, a gas-sealing material and gaskets are arranged on the periphery of the electrodes, with the polymer electrolyte membrane sandwiched there between. The sealing material and gaskets are assembled into a single part together with the electrodes and polymer electrolyte membrane to form a membrane and electrode assembly (MEA). Disposed outside of the MEA are conductive separator plates for mechanically securing the MEA and electrically connecting adjacent MEAs in series. A portion of the separator plate, which is disposed in contact with the MEA, is provided with a gas passage for supplying hydrogen fuel gas to the electrode surface and removing generated water vapor.

Because the proton conductivity of PEM fuel cell membranes deteriorates rapidly as the membranes dry out, external humidification is required to maintain hydration of the membranes and sustain proper fuel cell functioning. Moreover, the presence of liquid water in automotive fuel cells is unavoidable because appreciable quantities of water are generated as a by-product of the electrochemical reactions during fuel cell operation. Furthermore, saturation of the fuel cell membranes with water can result from rapid changes in temperature, relative humidity, and operating and shutdown conditions. However, excessive membrane hydration may result in flooding, excessive swelling of the membranes and the formation of differential pressure gradients across the fuel cell stack.

Because the balance of water in a fuel cell is important to operation of the fuel cell, water management has a major impact on the performance and durability of fuel cells. Fuel cell degradation with mass transport losses due to poor water management remains a concern for automotive applications. Long-term exposure of the membrane to water can also cause irreversible material degradation. Water management strategies such as the establishment of pressure and temperature gradients and counter flow operation have been implemented and have been found to reduce mass transport to some degree, especially at high current densities. However, optimum water management is still needed for optimum performance and durability of a fuel cell stack.

Accordingly, there exists a need for new and improved fuel cell elements that exhibit improved water management characteristics.

### SUMMARY OF THE INVENTION

In accordance with a first embodiment of the present invention, there is provided a method of modifying the surface of a fuel cell element is provided, comprising: (1) providing a fuel cell element having a surface formed thereon; and (2) depositing a thin film on the surface of the fuel cell element by physical vapor deposition.

In accordance with an alternate embodiment of the present invention, a method of modifying the surface of a fuel cell element is provided, comprising: (1) providing a fuel cell element having a surface formed thereon; and (2) depositing a thin film on the surface of the fuel cell element by physical vapor deposition, wherein the thin film comprises a super hydrophilic surface.

In accordance with an alternate embodiment of the present invention, a fuel cell system is provided, comprising a fuel cell element having a surface formed thereon, wherein the surface of the fuel cell element has a thin film deposited thereon by physical vapor deposition.

### BRIEF DESCRIPTION OF THE DRAWINGS

Advantages of the present invention will be more fully appreciated from the detailed description when considered in connection with accompanying drawings of presently preferred embodiments which are given by way of illustration only and are not limiting wherein:

FIG. 1 is a schematic view of a fuel cell, in accordance with the general teachings of the present invention;

FIG. 2 is a Scanning Electron Microscope (i.e., SEM) view of a thin layer of bismuth that has been applied by physical vapor deposition on a single crystal silicon substrate, in accordance with a first embodiment of the present invention;

FIG. 3 is a SEM view of a sample of bulk bismuth, in accordance with the prior art;

FIG. 4 shows the contact angle measurement of a thin bismuth film, in accordance with a first alternative embodiment of the present invention; and

FIG. 5 shows the contact angle measurement of bulk bismuth, in accordance with the prior art.

### DETAILED DESCRIPTION OF THE INVENTION

The present invention generally relates to a Physical Vapor Deposition (i.e., PVD) method of enhancing the water management capabilities of a fuel cell by creating super hydrophilic surfaces of various fuel cell components, particularly the bipolar plate components of the fuel cell.

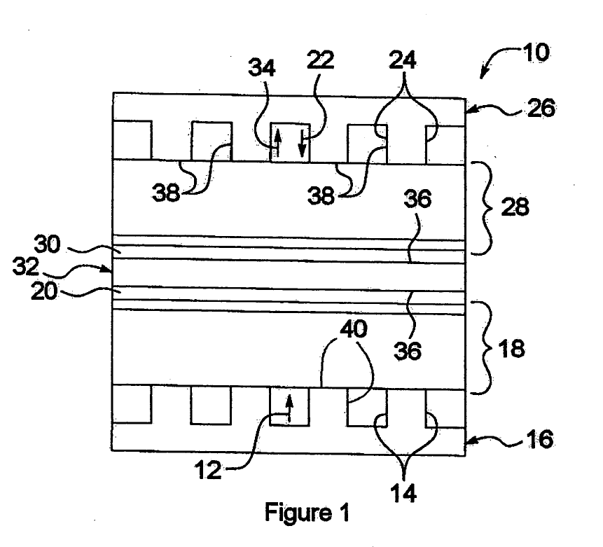

A fuel cell system is generally shown at 10 in FIG. 1. During operation of the fuel cell system 10, hydrogen gas 12 flows through the flow field channels 14 of a bipolar plate generally indicated at 16 and diffuses through the gas diffusion medium 18 to the anode 20. In like manner, oxygen 22 flows through the flow field channels 24 of the bipolar plate generally indicated at 26 and diffuses through the gas diffusion medium 28 to the cathode 30. At the anode 20, the hydrogen 12 is split in to electrons and protons. The electrons are distributed as electrical current from the anode 20, through a drive motor (not shown) and then to the cathode 30. The protons migrate from the anode 20, through the PEM generally indicated at 32 to the cathode 30. At the cathode 30, the protons are combined with electrons returning from the drive motor (not shown) and oxygen 22 to form water 34. The water vapor 34 diffuses from the cathode 30 through the gas diffusion medium 28, into the field flow channels 24 of the bipolar plate 26 and is discharged from the fuel cell stack 10.

During transit of the water vapor 34 from the cathode 30 to the bipolar plate 26 and beyond, the hydrophilic or hydrophobic bipolar plate surfaces 38, 40, respectively, of the bipolar plates 26,16, respectively, aid in water management.

Thus, it is well known that in a fuel cell stack at the cathode side, the fuel cell generates water in the catalyst layer. The water must leave the electrode. Typically, the water leaves the electrode through the many channels 24 of the element or bipolar plate 26. Typically, air passes through the channels and pushes the water through the channels 24. A problem that arises is that the water creates a slug in the channels 24 and air cannot get to the electrodes. When this occurs, the catalyst layer near the water slug will not work. When a water slug forms, the catalyst layer near the slug becomes ineffective. This condition is sometimes referred to as flooding of the fuel cell. The result of flooding is a voltage drop that creates a low voltage cell in the stack.

A similar phenomenon holds true on the anode side of the cell. On the anode side of the cell, hydrogen can push the water through the channels 14 of the element or bipolar plate 16.

Often times, when a voltage drop occurs, the voltage drop continues to worsen. When one of the channels 14, 24, respectively, in the plate 16, 26, respectively, becomes clogged, the water rate passing through the other channels in the plate increases. Eventually, the cell, with insufficient gas flow to force water out through its channels, saturates with water and may flood. Because the stack is connected electrically in series, eventually the whole fuel cell stack may flood with water and shut down. Accordingly, it is desirable to improve the water management properties of the bipolar plates to enhance stack performance and durability and eliminate low performance cells.

One attempt to solve the problem has been to increase the velocity of the gas, air on one side or hydrogen on the other, to move the water through the channels. However, this is an inefficient method for clearing the water from the channels.

According to one embodiment of the present invention, the surfaces 38, 40, respectively, of the fuel cell elements or bipolar plates 16, 26, respectively, are modified to improve water management. More specifically, the surfaces 38, 40, respectively, of the bipolar plates 16, 26, respectively, are modified to form super hydrophilic surfaces. Super hydrophilic surfaces on fuel cell bipolar plates are desirable for improving water management and thus increasing fuel cell efficiency. Likewise, super hydrophobic surfaces are desirable for improving water management, thus increasing fuel cell efficiency. A super hydrophilic surface helps in forming a thin film of water, easily removed through the channels 14, 24, respectively, especially at relatively low or reduced pressure levels. This aids in preventing water slug formation in the channels 14, 24, respectively. Super hydrophilic or super hydrophobic surfaces can, in theory, be created according to Wenzel's model or Cassie-Baxter's model by making highly rough surfaces on hydrophilic or hydrophobic materials.

According to the method, such highly rough surfaces can be created by depositing thin films on the surface of the fuel cell component by PVD. More specifically, a sputtering process is used to create the thin film on the surface of the fuel cell component. The PVD deposition of the thin film creates a super hydrophilic surface which helps in the transport of water inside the fuel cell and thereby enhances water management.

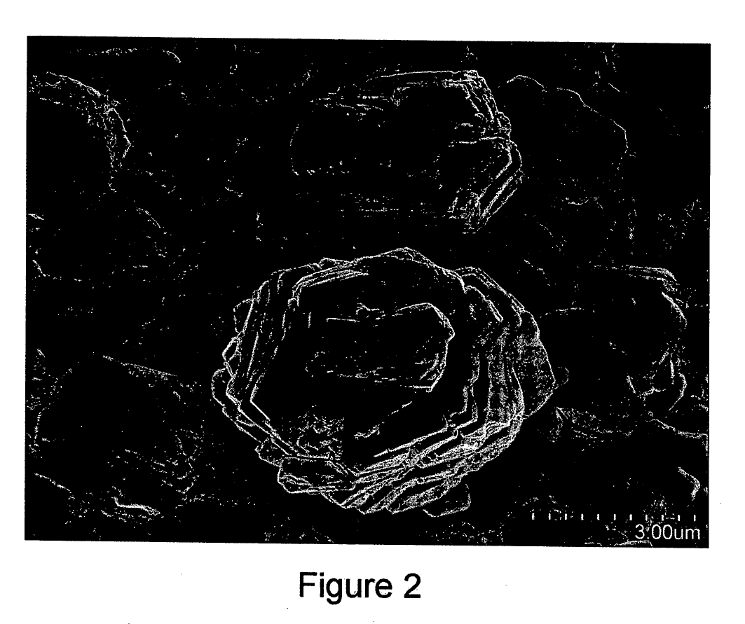

FIG. 2 shows the SEM image of a thin film deposited by PVD onto a substrate. Specifically, FIG. 2 shows a thin bismuth film that has been sputtered onto a single crystal silicon substrate. As can be seen in FIG. 2, there is provided a multi-level roughness on the micrometer and nanometer levels. Without being bound to a particular theory of the operation of the present invention, it is believed that the presence of the bismuth film is responsible for the super hydrophilicity.

The film of bismuth was prepared in a commercial closed field unbalanced magnetron sputtering system (Teer550). A 99.9 percent pure bismuth sputter target was used for the bismuth deposition. Sample films were deposited on both single crystal silicon and steel substrates. The substrates were cleaned ultrasonically in acetone and methanol before introduction into the vacuum chamber. The base pressure of the vacuum system was 6×10⁶ Torr. Immediately before deposition, the substrates were Ar-ion etched for about 20 minutes with the substrates biased at −400 V. The substrate bias voltage was −60 V for all the samples during deposition. Voltage pulses of 500 nsec pulse width and 250 kHz frequency were used. The sputtering gas was pure argon of 99.999 percent purity. The substrate temperature was less than 150° C. The thickness of the deposited films is in the range of 1-2 micrometers. FIG. 2 is representative of the samples after sputtering.

The films formed during the sputtering process were bismuth with a thin layer of native oxide of less than 3 nm on the surfaces of the bismuth films. The native oxide layer is formed when the samples are exposed to air.

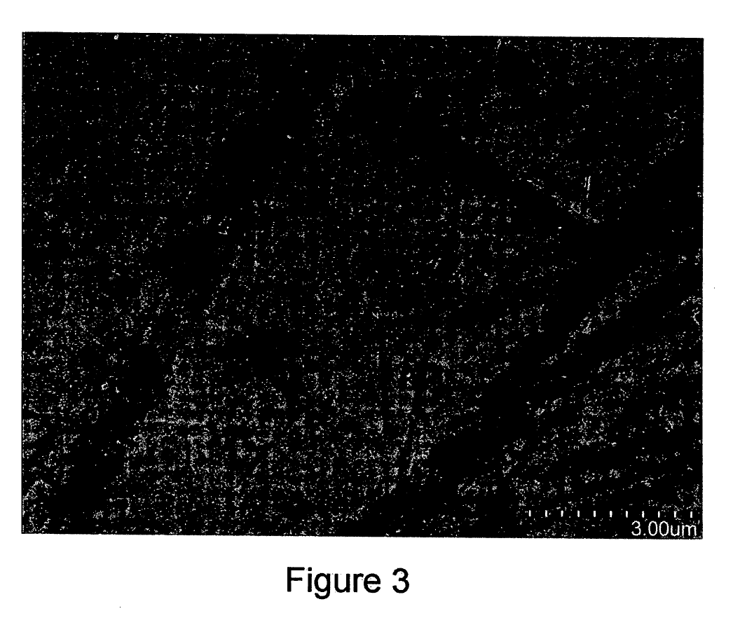

FIG. 3 is an SEM image of bulk bismuth. A comparison of FIGS. 2 and 3 shows that the multilevel roughness on the thin bismuth film is evident.

The water contact angle was measured using a Krüss DSA10L Drop Shape Analysis system operated in air at 23° C. and 60 percent relative humidity. The drop fluid used was 18MΩ deionized water that had been double distilled. The static water contact angle on the surface of the thin films of bismuth is about 2 to about 8 degrees in contrast to 90 degrees on the surface of the bulk bismuth. Super hydrophilicity is usually defined as a static contact angle of less than 10 degrees. Such super hydrophilic surfaces were created by sputtering thin bismuth films onto the substrates.

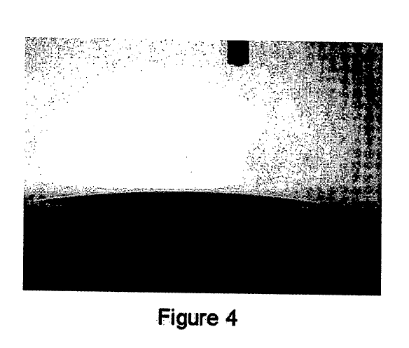

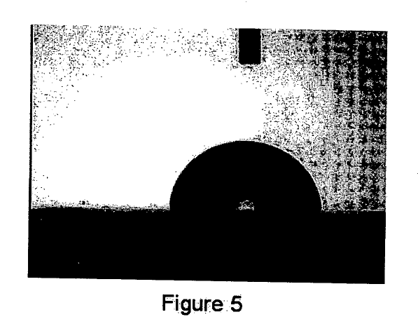

FIG. 4 shows the static contact angle for a thin bismuth film in accordance with the method set forth above. This shows the contact angle in the range of about 2 to about 8 degrees. FIG. 5 shows the static contact angle for bulk bismuth. As shown, the contact angle for bulk bismuth is about 90 degrees.

By roughing the surface utilizing the sputtering technology, the super hydrophilic surface is created. As best seen in FIG. 2, the roughness is such that water can easily spread. Thus, the water droplet spreads over the surface. This hydrophilic surface should be kept free from contamination in order to maintain their hydrophilicity.

Accordingly, the super hydrophilic surface improves water management in the fuel cell stack. Further, the super hydrophilic surface enhances the low power stability of the stacks. Additionally, the surface modification also improves material degradation properties. Moreover, it protects all MEA materials from contamination.

Gold may be vapor deposited on the hydrophilic bipolar plate surface. By way of example, the application of 10 nanometers of gold by vapor deposition reduces electrical contact resistance between the diffusion paper and the bipolar plate surface.

While the thin film described herein is bismuth, it will be appreciated that other suitable films may be used within the scope of the present invention. By way of a non-limiting example, the other films may include metal, ceramics, and their composites. Such films may also comprise, by way of a non-limiting example, noble metals, semi-metals, carbon based materials, and mixtures thereof. In some instances, bismuth may be unstable in a fuel cell environment, thus other films may be more compatible with the fuel cell environment. Again, it will be appreciated that any suitable film may be used in accordance with the present invention.

The invention has been described in an illustrative manner, and it is to be understood that terminology which has been used is intended to be in the nature of words of description, rather than of limitation. Many modifications and variations of the present invention in light of the above teachings.

What is claimed is:

1. A method of modifying the surface of a fuel cell element, comprising:
providing a fuel cell element having a surface formed thereon; and
depositing a thin film on the surface of the fuel cell element by physical vapor deposition.

2. The invention of claim 1, wherein sputtering is employed for the physical vapor deposition of the thin film.

3. The invention of claim 1, wherein thermal evaporation is employed for the physical vapor deposition of the thin film.

4. The invention of claim 1, wherein electron-beam evaporation is employed for the physical vapor deposition of the thin film.

5. The invention of claim 1, wherein the thin film comprises a super hydrophilic surface.

6. The invention of claim 1, wherein the thin film has a contact angle of less than 10 degrees.

7. The invention of claim 1, wherein the thin film is comprised of bismuth.

8. The invention of claim 1, wherein the thin film is comprised of a material selected from the group consisting of metals, ceramics, composites of metals or ceramics, and combinations thereof.

9. The invention of claim 1, wherein the thin film is comprised of a material selected from the group consisting of noble metals, semi-metals, carbon based materials, and combinations thereof.

10. The invention of claim 1, wherein the thin film facilitates water flow at reduced pressure.

11. A method of modifying the surface of a fuel cell element, comprising:
providing a fuel cell element having a surface formed thereon; and
depositing a thin film on the surface of the fuel cell element by physical vapor deposition;
wherein the thin film comprises a super hydrophilic surface.

12. The invention of claim 11, wherein sputtering is employed for the physical vapor deposition of the thin film.

13. The invention of claim 11, wherein thermal evaporation is employed for the physical vapor deposition of the thin film.

14. The invention of claim 11, wherein electron-beam evaporation is employed for the physical vapor deposition of the thin film.

15. The invention of claim 11, wherein the thin film has a contact angle of less than 10 degrees.

16. The invention of claim 11, wherein the thin film is comprised of bismuth.

17. The invention of claim 11, wherein the thin film is comprised of a material selected from the group consisting of metals, ceramics, composites of metals or ceramics, and combinations thereof.

18. The invention of claim 11, wherein the thin film is comprised of a material selected from the group consisting of noble metals, semi-metals, carbon based materials, and combinations thereof.

19. The invention of claim 11, wherein the thin film facilitates water flow at reduced pressure.

20. A fuel cell system, comprising:
a fuel cell element having a surface formed thereon;
wherein the surface of the fuel cell element has a thin film deposited thereon by physical vapor deposition.

21. The invention of claim 20, wherein sputtering is employed for the physical vapor deposition of the thin film.

22. The invention of claim 20, wherein thermal evaporation is employed for the physical vapor deposition of the thin film.

23. The invention of claim 20, wherein electron-beam evaporation is employed for the physical vapor deposition of the thin film.

24. The invention of claim 20, wherein the thin film comprises a super hydrophilic surface.

25. The invention of claim 20, wherein the thin film has a contact angle of less than 10 degrees.

26. The invention of claim 20, wherein the thin film is comprised of bismuth.

27. The invention of claim 20, wherein the thin film is comprised of a material selected from the group consisting of metals, ceramics, composites of metals or ceramics, and combinations thereof.

28. The invention of claim 20, wherein the thin film is comprised of a material selected from the group consisting of noble metals, semi-metals, carbon based materials, and combinations thereof.

29. The invention of claim 20, wherein the thin film facilitates water flow at reduced pressure.
